(19) United States
(12) Patent Application Publication
(10) Pub. No.: US 2026/0244145 A1
(43) Pub. Date: Aug. 20, 2026

(54) SYSTEM AND CONTROL METHOD THEREOF

(71) Applicant: CANON KABUSHIKI KAISHA, Tokyo (JP)

(72) Inventor: TOSHIKAZU KINKOH, Kanagawa (JP)

(21) Appl. No.: 19/465,060

(22) Filed: Jan. 30, 2026

(30) Foreign Application Priority Data
Feb. 17, 2025 (JP) 2025-023347

(51) Int. Cl. G03G 15/00

(52) U.S. Cl. CPC G03G 15/553

(57) ABSTRACT

A system for predicting a lifespan of a consumable part of a device receives data of a consumable part collected in the device, the data including a consumed level of the consumable part and a consumed level estimation unit that was used for estimation of the consumed level, predicts a lifespan of the consumable part based on the consumed level included in the received data, and generates and provides a UI configured to display the predicted lifespan of the consumable part and information based on a type of the consumed level estimation unit.

### BACKGROUND

### Field of the Technology

The present disclosure relates to a system for predicting a lifespan of consumable parts of a device, and a control method thereof.

### Description of the Related Art

Electrophotographic image forming apparatuses (hereinafter, devices), which form visualized images by charging, exposure, and development scanning, include consumable parts that require periodic replacement in addition to paper and toner. Specifically, examples include a development unit, a photosensitive drum, an ITB (Intermediate Transfer Belt), a fixing unit, a paper feed roller of a paper feed deck, and the like. When a lifespan of these parts is exceeded, failures such as image defects, errors, and the like occur. For this reason, in recent years, a mechanism has been proposed that predicts a lifespan of consumable parts (a replacement timing of the parts) and completes replacement at a user site before the lifespan of the consumable parts is reached. Although lifespan prediction is performed by monitoring a consumed level of the consumable parts, a prediction method of the consumed level has been either to use a counter value based on a number of times the parts have been used or to use a so-called “life value” calculated by the parts based on inherent logic. In general, a consumed level based on a life value is more accurate. In addition, in recent years, a micro device called a sensing device is mounted in consumable parts, and by measuring various information at the time of device operation, more accurate estimation of the consumed level has become possible. Furthermore, there is a case in which logic for estimating the consumed level itself is improved by a version upgrade of the device. Japanese Patent Application Laid-Open No. 2021-124763 discloses a method for determining priority based on prediction history of whether to use a life value or a counter value for each part.

However, in Japanese Patent Application Laid-Open No. 2021-124763, although a life value or a counter value is used for lifespan estimation of parts, which value was used for calculation is not made recognizable to a user (a system user) on the system. For a customer engineer who is a system user, by what kind of calculation the lifespan estimation was performed is directly related to accuracy of lifespan estimation of the parts and is important. When understanding on the system what kind of estimated value of the consumed level was used as a basis for performing remaining lifespan prediction is not possible, determination of an appropriate replacement timing of the parts becomes difficult. For this reason, enabling a system user to understand on the system how the consumed level used as a basis for the remaining lifespan prediction was estimated is required.

### SUMMARY

The present disclosure enables a user to recognize a consumed level estimation unit that was used in a system that predicts a lifespan of consumable parts of a device.

A system according to the present disclosure includes an information processing apparatus configured to predict a lifespan of consumable parts of a device, the information processing apparatus comprising: a memory storing instructions; and a processor executing the instructions causing the information processing apparatus to receive data of consumable parts, the data having been collected in the device and including a consumed level of the consumable parts and a consumed level estimation unit that was used for estimation of the consumed level, predict the lifespan of the consumable parts based on the consumed level of consumable parts included in the collected data of consumable parts received from the device, and generate and provide a user interface (UI) configured to display the predicted lifespan of the consumable parts and information based on the type of the consumed level estimation unit.

Features of the present disclosure will become apparent from the following description of embodiments with reference to the attached drawings. The following description of embodiments is described by way of example.

### BRIEF DESCRIPTION OF THE DRAWINGS

FIG. 1 is a diagram showing an entire configuration of a system.

FIG. 2 is a diagram showing a hardware configuration of a part lifespan prediction server 101.

FIG. 3 is a diagram showing a hardware configuration of a device 102.

FIG. 4 is a diagram showing a software configuration of the system.

FIG. 5 is a flowchart showing estimation processing of a consumed level of consumable parts.

FIG. 6 is a diagram showing an example of a consumed level estimation unit selection table.

FIG. 7 is a flowchart showing update processing of a remaining number of lifespan days of parts.

FIG. 8 is a diagram explaining notification information of a consumed level.

FIG. 9 is a diagram explaining parts information.

FIG. 10 is a diagram showing an example of a web application screen.

FIG. 11 is a diagram explaining device information.

### DESCRIPTION OF THE EMBODIMENTS

### First Embodiment

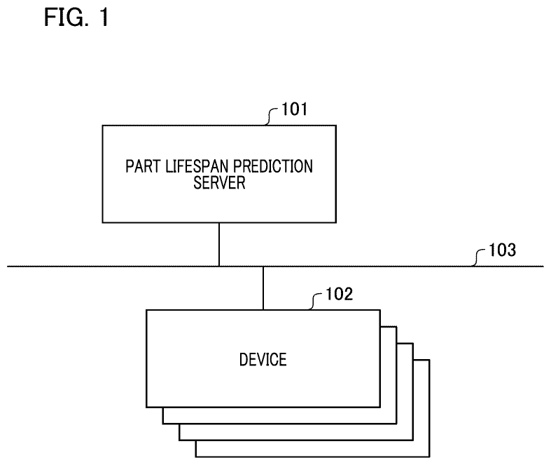

FIG. 1 is a diagram showing an entire configuration of a system. The system of the present embodiment is a system that predicts a lifespan of consumable parts of a device. The system comprises a part lifespan prediction server 101 and a device 102, and the part lifespan prediction server 101 and the device 102 are connected to each other via a network 103 so as to be capable of communication. It should be noted that the system may be a configuration that includes, in addition to the part lifespan prediction server 101 and the device 102, servers that provide additional functions or services.

The device 102 is a network device that uses consumable parts. A plurality of devices 102 that are managed in the system may be provided. The device 102 is, for example, a multifunction peripheral (MFP: Multifunction Peripheral) that is an image processing apparatus in which a plurality of functions such as a printing function, a reading function, a FAX function, and the like are integrated. It should be noted that the device 102 is not limited to an MFP, and may be an image processing apparatus that is a printer, a scanner, a 3D printer, and the like, and that has any of a printing function, a copy function, a scan function, a data network transmission function, and a FAX function.

The device 102 of the present embodiment collects data of consumable parts in the device based on a request from the part lifespan prediction server 101 and notifies the part lifespan prediction server 101 of the data. In addition, the device 102 performs processing for estimating a consumed level of each consumable part when collecting data of consumable parts. In processing of estimating the consumed level of consumable parts, a consumed level estimation algorithm (consumed level estimation unit), the consumed level estimation algorithm being an algorithm for estimating the consumed level, is used. The data of consumable parts that are notified from the device 102 to the part lifespan prediction server 101 includes a consumed level that was calculated by estimation processing and information identifying a consumed level estimation algorithm that was used for estimation of the consumed level.

The part lifespan prediction server 101 predicts, as a lifespan of consumable parts of the device 102, remaining number of days until end of life. More specifically, the part lifespan prediction server 101 calculates progress of the consumed level (hereinafter, referred to as consumption progress) by collecting the consumed level of consumable parts of the device 102 as time-series data, and the part lifespan prediction server 101 calculates remaining number of days until end of life from the consumption progress and from the consumed level of the consumable parts. The consumed level is notified from the device 102 to the part lifespan prediction server 101. It should be noted that, in the present embodiment, although the device 102 and the part lifespan prediction server 101 are configured to directly communicate, a server other than the part lifespan prediction server 101 may intervene. The part lifespan prediction server 101 may be configured by a single information processing apparatus, or may be configured by a plurality of device groups by cloud computing technology. That is, the part lifespan prediction server 101 may be realized by one or a plurality of information processing apparatuses, by a virtual machine (cloud service) that uses resources that were provided by a data center that includes information processing apparatuses, or by a combination of the information processing apparatuses and the virtual machine.

The part lifespan prediction server 101 and the device 102 are connected via the network 103. The network 103 is, for example, a communication network that is realized by any of a LAN (Local Area Network), a WAN (Wide Area Network) such as the Internet, or a combination of the LAN and the WAN. It should be noted that the network 103 need only be configured so as to be capable of transmitting and receiving data, and the communication method is not limited. For example, the network 103 is configured by any of a LAN, a WAN, a cellular network of LTE, 5G, and the like, a wireless network, a telephone line, a dedicated digital line, and the like, or a combination thereof.

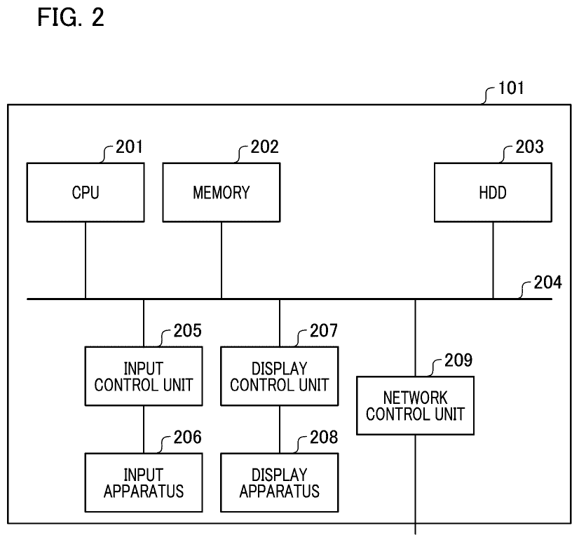

FIG. 2 is a diagram showing a hardware configuration of the part lifespan prediction server 101. The part lifespan prediction server 101 comprises a CPU 201, a memory 202, an HDD 203, an input control unit 205, an input apparatus 206, a display control unit 207, a display apparatus 208, and a network control unit 209. The CPU 201, the memory 202, the HDD 203, the input control unit 205, the display control unit 207, and the network control unit 209 are connected to a system bus 204.

The CPU (Central Processing Unit) 201 controls the part lifespan prediction server 101 as a whole by controlling each hardware component that is connected to the system bus 204 in an integrated manner. The memory 202 functions as a main memory of the CPU 201, a work area, and the like. The HDD 203 (Hard Disk Drive) is a large-capacity storage apparatus that has a nonvolatile storage area. The HDD 203 stores an OS (Operating System), data, software programs, and the like. It should be noted that, in the present embodiment, although a case in which a nonvolatile large-capacity storage apparatus is an HDD is explained as an example, the nonvolatile large-capacity storage apparatus is not limited to this example, and for example, the large-capacity storage apparatus may be an SSD (Solid State Drive) and the like. The CPU 201 executes various control processing by executing programs that are stored in the memory 202 or the HDD 203 by expanding the programs into a memory 202.

The input apparatus 206 receives operations from a user. The input apparatus 206 is, for example, a keyboard, a pointing device, and the like. The input control unit 205 controls input from the input apparatus 206. The display apparatus 208 performs display with respect to the user. The display apparatus 208 is, for example, a display that is a liquid crystal screen and the like. The display control unit 207 controls display on the display apparatus 208. It should be noted that the input apparatus 206 and the display apparatus 208 may be realized by an integrated touch panel. By associating input coordinates and display coordinates on the touch panel, a graphical user interface (GUI) can be configured as if the user is capable of directly operating a screen that is displayed on the touch panel. The network control unit 209 transmits and receives data bidirectionally to and from an external apparatus via the network 103. In the present embodiment, the network control unit 209 performs communication with the device 102 via the network 103.

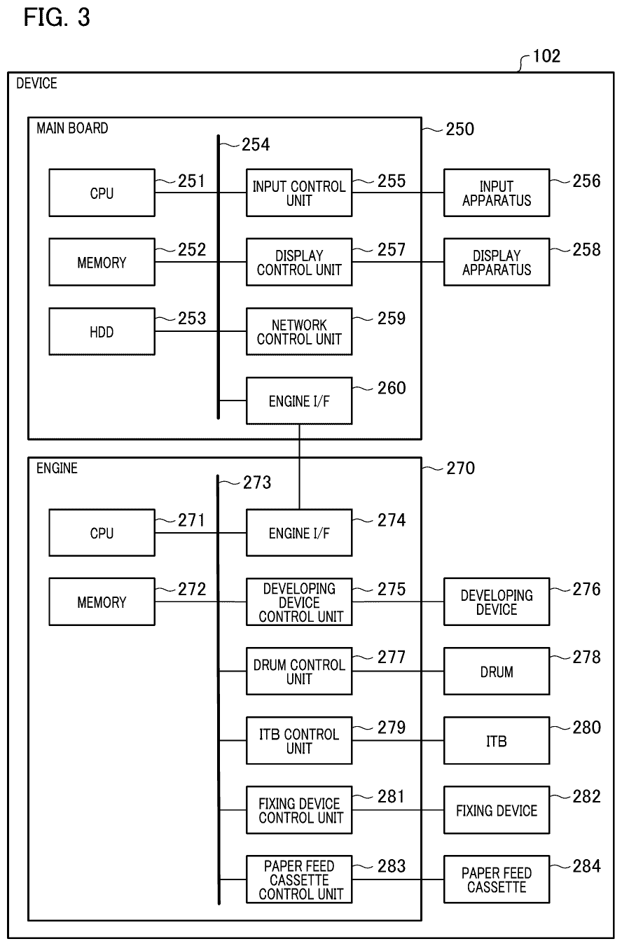

FIG. 3 is a diagram showing a hardware configuration of the device 102. The device 102 that is an image processing apparatus comprises a main board 250, an input apparatus 256, a display apparatus 258, an engine 270, a developing device 276, a drum 278, an ITB 280, a fixing device 282, and a paper feed cassette 284. The main board 250 and the engine 270 are connected via the engine I/F 260 of the main board 250 and an engine I/F 274 of the engine 270.

The main board 250 receives an output instruction, converts the output instruction to data that is processable by the engine 270, and transmits the data to the engine 270 as an output instruction. The engine 270 that has received the instruction that was output from the main board 250 executes processing based on the instruction. For example, in the case of printing, the main board 250 receives PDL (Printer Description Language) data as a print instruction from the information processing apparatus. Then, the main board 250 converts the received PDL data to bitmap data for printing, and the main board 250 transmits the bitmap data to the engine 270.

The main board 250 comprises a CPU 251, the memory 252, an HDD 253, an input control unit 255, a display control unit 257, a network control unit 259, and an engine I/F 260. The CPU 251, the memory 252, the HDD 253, the input control unit 255, the display control unit 257, the network control unit 259, and the engine I/F 260 are mutually connected by a system bus 254. The CPU 251 controls the main board 250 by controlling each hardware component that is connected to the system bus 254 in an integrated manner. The memory 252 functions as a main memory of the CPU 251, a work area, and the like. The HDD 253 is a nonvolatile storage area, and the HDD 253 stores data, programs, and the like as a large-capacity storage apparatus. The memory 252 or the HDD 253 stores controller firmware. The CPU 251 expands the controller firmware (program) that is stored in the memory 252 or the HDD 253 into the memory 252, and realizes various control by executing the controller firmware (program).

The input apparatus 256 receives operations from a user. The input apparatus 256 is, for example, a keyboard, a pointing device, and the like. The input control unit 255 controls input from the input apparatus 256. The display apparatus 258 performs display with respect to the user. The display apparatus 258 is, for example, a display that is a liquid crystal screen and the like. The display control unit 257 controls display on the display apparatus 258. It should be noted that the input apparatus 256 and the display apparatus 258 may be realized by an integrated touch panel. The network control unit 259 transmits and receives data bidirectionally to and from an external apparatus via the network 103. In the present embodiment, the network control unit 259 performs communication with the information processing apparatus 101 via the network 103. The engine I/F 260 interconnects the main board 250 and the engine 270.

The engine 270 comprises a CPU 271, a memory 272, the engine I/F 274, a developing device control unit 275, a drum control unit 277, an ITB control unit 279, a fixing device control unit 281, and a paper feed cassette control unit 283, and the CPU 271, the memory 272, the engine I/F 274, the developing device control unit 275, the drum control unit 277, the ITB control unit 279, the fixing device control unit 281, and the paper feed cassette control unit 283 are interconnected by a system bus 273. The CPU 271 controls the engine 270 by comprehensively controlling each hardware component that is connected to the system bus 273. The memory 272 functions as a main memory of the CPU 271, a work area, and the like. The memory 272 stores engine firmware. The CPU 271 loads the engine firmware (program) stored in the memory 272 into the memory 272 and executes the engine firmware (program), thereby implementing various control operations. The engine I/F 274 connects the engine 270 and the main board 250 via the engine I/F 260.

The developing device 276 receives an instruction from the engine firmware via the developing device control unit 275, and the developing device 276 develops an image that is to be output by toner (not shown) on the drum 278 based on the received instruction. The developing device control unit 275 controls the developing device 276. The drum 278 forms an electrostatic latent image according to an output image on the drum 278 by being charged by a charging apparatus (not shown) and by being further exposed by an exposure apparatus (not shown). After formation of the electrostatic latent image by the drum 278, the image is developed by the developing device 276. The drum 278 is provided for each color of cyan, magenta, yellow, and black, and a color image is formed by performing processing of forming the electrostatic latent image for each color and superimposing the electrostatic latent images on the ITB 280. In the present embodiment, although a case in which the same part (the drum 278) is used for cyan, magenta, yellow, and black is explained as an example, the parts may differ for each color. The drum control unit 277 controls the drum 278.

The ITB 280 receives an instruction from the engine firmware via the ITB control unit 279, and the ITB 280 transfers toner on the drum 278 to the ITB 280 based on the received instruction. The ITB control unit 279 controls the ITB 280. The fixing device 282 fixes the toner that was transferred onto the ITB 280 as a print image on paper by applying high temperature and high pressure to the toner. The fixing device control unit 281 controls the fixing device 282 The paper feed cassette 284 stores paper that is to be used for printing. The paper feed cassette 284 receives an instruction from the engine firmware via the paper feed cassette control unit 283, and the paper feed cassette 284 feeds paper that is to be used for printing based on the received instruction. The paper feed cassette 284 comprises a paper feed roller (not shown), and the paper feed cassette 284 conveys the paper by the paper feed roller. The paper feed cassette control unit 283 controls the paper feed cassette 284.

The developing device 276, the drum 278, the ITB 250, the fixing device 282, and the paper feed cassette 284 are examples of parts that execute output processing of the device 102. The developing device 276, the drum 278, the ITB 250, the fixing device 282, and the paper feed cassette 284 are consumable parts that are consumed by execution of output processing (printing processing) of the device 102 and that require replacement of the parts according to a lifespan of each part. The consumable parts are attachable to and detachable from the device 102, and the consumable parts can be replaced on a consumable-part basis. That is, the developing device 276, the drum 278, the ITB 250, the fixing device 282, and the paper feed cassette 284 are consumable parts of the device 102. The developing device control unit 275, the drum control unit 277, the ITB control unit 279, the fixing device control unit 281, and the paper feed cassette control unit 283 are control units of the consumable parts. Each consumable part and the control unit of the consumable part communicate via wired communication such as GPIO (General-Purpose Input/Output) and the like, or via proximity wireless communication such as RFID (Radio Frequency Identification) and the like. It should be noted that the device 102 may comprise consumable parts other than the developing device 276, the drum 278, the ITB 280, the fixing device 282, and the paper feed cassette 284 explained in the present embodiment.

The consumed level of each consumable part differs depending on the usage conditions of the device 102. For this reason, by replacing some parts that have reached end of life, the device 102 itself does not require replacement, and the device 102 can be continuously used. In addition, each consumable part comprises a memory tag (not shown). In the memory tag, usage information is stored, and the usage information indicates a part serial for identifying the consumable part and the consumed level of the consumable part. The usage information of the memory tag can be read by the control unit of the consumable part via a memory tag I/F (not shown).

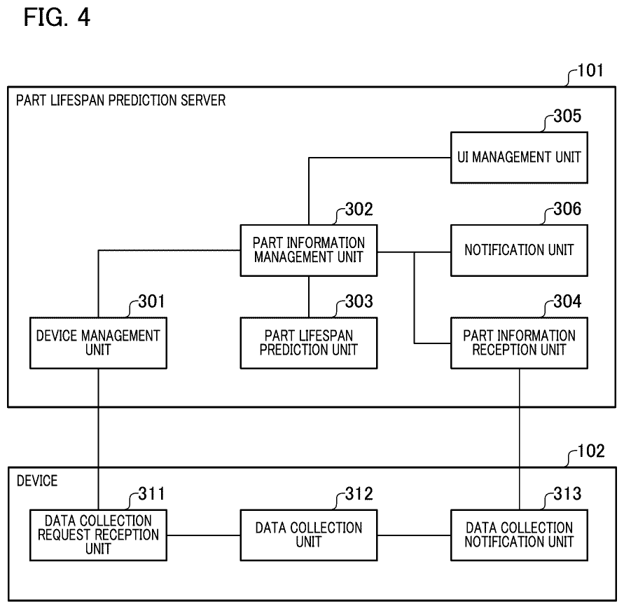

FIG. 4 is a diagram showing a software configuration of the system. First, explanation is provided with respect to the software configuration of the part lifespan prediction server 101. Programs that realize the software configuration of the part lifespan prediction server 101 are read from memory (memory 202, HDD 203), and are executed by the CPU 201. The part lifespan prediction server 101 includes a device management unit 301, a part information management unit 302, a part lifespan prediction unit 303, a part information reception unit 304, a UI management unit 305, and a notification unit 306.

The device management unit 301 manages device information of target devices for which the part lifespan prediction server 101 obtains part lifespans. Target devices are added or deleted by device registration or deletion instructions to the part lifespan prediction server 101. Alternatively, a configuration may be used in which, among devices that are managed by a separate server that integrally manages device information, devices that have license information indicating whether or not a part lifespan prediction function by the part lifespan prediction server 101 is enabled are used as target devices. In the present example, the device 102 is a target device.

In addition, the device management unit 301 transmits a data collection request to the device 102. The data collection request includes a consumed level notification request for consumable parts of the device 102. The consumed level notification request is an instruction that requests periodic notification of a consumed level of consumable parts within the device 102 to the part lifespan prediction server 101. It should be noted that the data collection request may include other data collection instructions such as replacement information of consumable parts and the like. The part information reception unit 304 receives consumed level notifications of consumable parts and the like that are notified by the device 102 that has received the consumed level notification request.

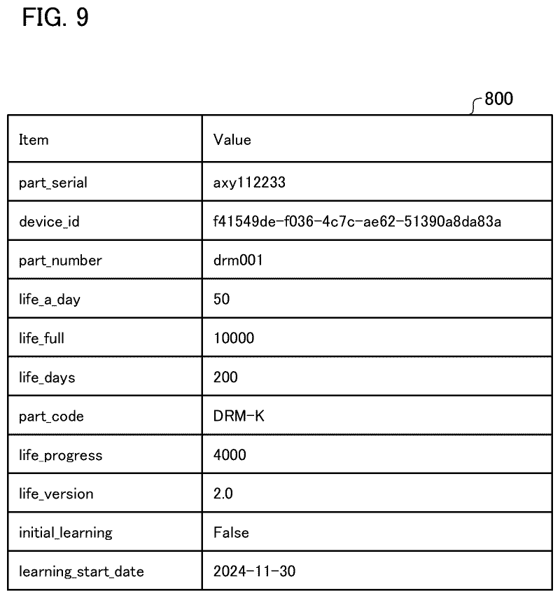

The part information management unit 302 manages part information of target devices of the part lifespan prediction server 101. The part information includes key information for specifying parts and installation destinations of the parts, a consumed level of the parts, remaining number of days until replacement that are calculated by lifespan prediction, and a consumption progress indicating progress of consumption. In addition, the part information includes information indicating a consumed level estimation unit (consumed level estimation algorithm) that was used for estimation of the consumed level of the parts. In the present embodiment, the part information management unit 302 manages part information of the device 102. The part information is described by using FIG. 9.

The part lifespan prediction unit 303 predicts a lifespan of consumable parts based on a consumed level included in data of the consumable parts of the device 102 that was received by the part information reception unit 304. The lifespan is obtained as remaining number of days until replacement of the parts. More specifically, the part lifespan prediction unit 303 calculates the lifespan of the consumable parts based on the consumed level included in data of the consumable parts and a consumption progress held by the part information management unit 302. In a case in which learning data for lifespan prediction exists when calculating the lifespan of the consumable parts, the part lifespan prediction unit 303 performs prediction of the lifespan of the consumable parts based on a consumed level of the learning data. The part lifespan prediction unit 303 notifies the part information management unit 302 of the calculated remaining number of days of the consumable parts, a latest consumed level, and an updated consumption progress. The part information management unit 302 that received notification from the part lifespan prediction unit 303 stores the remaining number of days of the consumable parts, the latest consumed level, and the updated consumption progress as parts information.

The UI management unit 305 generates and provides a UI (user interface) that is provided by the part lifespan prediction server 101. Functions that the part lifespan prediction server 101 provides are implemented, for example, as a web application. By the UI management unit 305, the UI that the part lifespan prediction server 101 provides is displayed on a web browser of a terminal (not shown) that performs communication with the part lifespan prediction server 101. The terminal may be the device 102, or may be a network device such as a tablet, a smartphone, a PC, and the like, that a system user has. In the present embodiment, a UI that the UI management unit 305 provides is a screen for confirming a condition (state) of the device 102. Condition information (information indicating a state of a device) is displayed in the UI. The condition information includes part information of the device 102. In the part information, information based on type of consumed level estimation unit is displayed together with a predicted lifespan of the consumable parts. It should be noted that, as the parts information, key information for specifying parts and installation destinations of the parts, a consumed level of the parts, and a consumption progress indicating progress of consumption may be displayed.

The web application is configured by HTML that expresses web pages, CSS (Cascading Style Sheets) as style sheets, and a programming language (JavaScript and the like) that operates on a web browser. In addition, parts information displayed on the web application is acquired by JavaScript that operates on the web browser via an API that the part information management unit 302 provides. The web application that the part lifespan prediction server 101 provides can be displayed and executed on any network node that can connect to the part lifespan prediction server 101 via a web browser. Customer engineers, and managers of the customer engineers, who handle maintenance of the device 102, arrangement of delivery of consumable parts, and the like, can confirm a UI that the part lifespan prediction server 101 provides online (on a web browser). The notification unit 306 issues various notifications to system users. The notification unit 306, for example, communicates directly or indirectly with a mail server (not shown), a cloud computing system (not shown), and the like.

Next, an explanation is provided with respect to the software configuration of the device 102. A program that realizes the software configuration relating to the main board 250 of the device 102 is read from the memory 252 or the HDD 253 and is executed by the CPU 251. A program that realizes the software configuration relating to the engine 270 of the device 102 is read from the memory 272 and is executed by the CPU 271. The device 102 includes a data collection request reception unit 311, a data collection unit 312, and a data collection notification unit 313.

The data collection request reception unit 311 receives a data collection request from the part lifespan prediction server 101 and notifies the data collection unit 312 of the received collection target. The data collection unit 312 holds data of the collection target that was notified by the data collection request reception unit 311 and collects various data within the device 102 based on the collection target. The data collection unit 312 transmits the collected data to the data collection notification unit 313. The data collection notification unit 313 notifies the part lifespan prediction server 101 of the data that was collected by the data collection unit 312.

In the present embodiment, the data collection request reception unit 311 receives a data collection request for a consumed level of consumable parts from the part lifespan prediction server 101. The data collection request reception unit 311 notifies the data collection unit 312 of a consumed level of consumable parts within the device as a collection target based on the data collection request for a consumed level of consumable parts. The data collection unit 312 periodically collects a consumed level of consumable parts within the device. The data collection unit 312 transmits the collected consumed level of consumable parts to the data collection notification unit 313. The data collection notification unit 313 transmits the consumed level of consumable parts to the part lifespan prediction server 101 that is the source of the data collection request for the consumed level of consumable parts. It should be noted that another server may be interposed between the part lifespan prediction server 101 and the device 102, and a server that issues a data collection request and a server that receives collected data may be physically different devices.

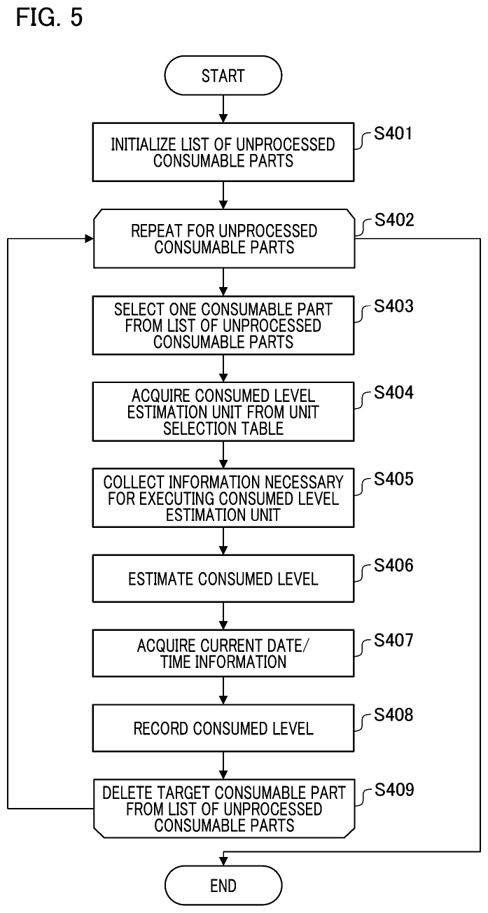

In this context, explanation is provided, by referring to FIG. 5, with respect to a method of estimating a consumed level of consumable parts within a device. FIG. 5 is a flowchart showing estimation processing of a consumed level of consumable parts. Estimation processing of a consumed level of consumable parts is executed in the device 102. In FIG. 5, each processing that the device 102 executes is realized by the CPU 271 reading out a program stored in the memory 272 and executing the program, and the like. Estimation processing of a consumed level of consumable parts is executed periodically, for example, based on a periodic collection request included in a data collection request of consumed level of consumable parts from the part lifespan prediction server 101. For example, estimation processing of a consumed level of consumable parts is started periodically every 12 hours by a timer apparatus (not shown) within the device 102. It should be noted that estimation processing of a consumed level of consumable parts may be executed irregularly, triggered by an instruction by a user from the input device 256 of the device 102 or some device operation such as device startup and the like.

The present processing is started by firing of a timer that is set at intervals of 12 hours, for example. In step S401, the data collection unit 312 creates, in the memory 272, data of a list of unprocessed consumable parts, and the data collection unit 312 writes all consumable parts that are mounted on the device 102 into the list of unprocessed consumable parts. Having all consumable parts written in the list of unprocessed consumable parts means that consumed level estimation processing has not been performed with respect to any consumable part.

In step S402, the data collection unit 312 refers to the list of unprocessed consumable parts that was created and enters iterative processing with respect to unprocessed consumable parts. Processing of steps S403 to S408 is executed iteratively with respect to unprocessed consumable parts. In step S402, the data collection unit 312 confirms whether an unprocessed consumable part exists. In a case in which an unprocessed consumable part exists, the data collection unit 312 proceeds to consumed level estimation processing. In contrast, in a case in which an unprocessed consumable part does not exist, that is, in a case in which consumed level estimation processing has ended with respect to all consumable parts, the data collection unit 312 ends the present processing.

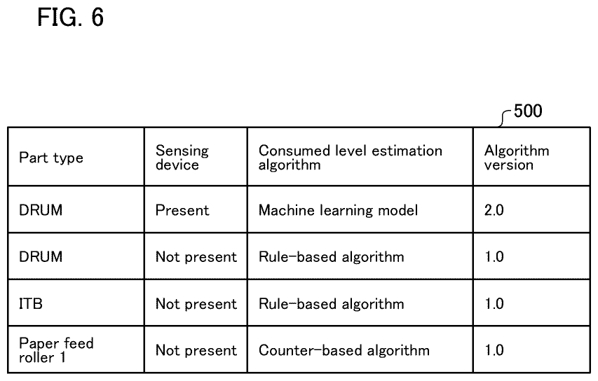

As consumed level estimation processing, processing of steps S403 to S408 is performed with respect to unprocessed consumable parts. In step S403, the data collection unit 312 selects one consumable part from the list of unprocessed consumable parts. In step S404, the data collection unit 312 acquires a consumed level estimation unit (consumable level estimation method) corresponding to the selected consumable part. The consumed level estimation unit is a consumed level estimation algorithm that the data collection unit 312 uses for consumed level estimation. In this context, the consumed level estimation unit that is referred to in step S404 is explained by using FIG. 6.

FIG. 6 is a diagram showing an example of a consumed level estimation unit selection table. A consumed level estimation unit selection table 500 is configured by, for example, a column for part type, a column for presence or absence of mounting of a sensing device, a column for type of consumed level estimation algorithm, and a column for algorithm version. For example, a consumed level estimation algorithm (consumable part estimation unit) is uniquely determined according to the part type and the presence or absence of mounting of a sensing device. It should be noted that although part type is written as a name in FIG. 6, a type code indicating the type may be used in actuality. In addition, the parts that are listed are merely examples, and the parts are not limited thereto. For example, drums may be handled commonly for each color, or may be managed separately according to toner color. A sensing device is a micro device capable of measuring information of each consumable part, including a current value, a temperature, a number of rotations, and the like. In recent years, there are consumable parts in which, by mounting a sensing device, it has become possible to estimate a consumed level that conforms to an actual state of the consumable part with higher accuracy.

In the present embodiment, types of consumed level estimation algorithms include a counter-based algorithm, a rule-based algorithm, and a machine learning model. The counter-based algorithm is a method of estimating the consumed level by dividing counter information by a design target value for each consumable part. The counter information is, for example, a value that is counted in each part. For example, in a paper feed roller, the number of printed sheets is the counter information. The rule-based algorithm is a method of estimating the consumed level by applying a rule that is determined in advance to the counter information. That is, although the rule-based algorithm is based on counter information, the rule-based algorithm is not simple division like the counter-based algorithm, and is a method in which processing determined in advance is performed on the counter information, and the consumed level is estimated. The machine learning model is a method of estimating the consumed level by inputting sensing information that is acquired from a sensing device to a machine learning model that was constructed in advance. For this reason, the machine learning model is a consumed level estimation unit that can be used in a case in which a sensing device that measures a consumable part is mounted. In the present embodiment, it is assumed that the machine learning model has the highest accuracy in estimation of the consumed level, and the accuracy decreases in order of the rule-based algorithm and the counter-based algorithm. In a case in which a plurality of consumed level estimation algorithms are available as options for a part that is a target of estimation of the consumed level, the data collection unit 312 selects, for example, a consumed level estimation algorithm having the highest accuracy in estimation. It should be noted that these estimation algorithms are examples, and are not limited thereto. The algorithm version is a numerical value that is assigned so as to allow identification of a consumed level estimation algorithm for each part type and identification of a version of the algorithm. Based on the algorithm version, a type of the consumed level estimation algorithm (consumed level estimation unit) and the version of the consumed level estimation algorithm can be determined. The algorithm version indicates, for example, that the larger a numerical value of the algorithm version, the newer the consumed level estimation algorithm, and that higher-accuracy consumed level estimation can be performed.

The consumed level estimation unit selection table 500 may be updated in association with an update of the firmware of the device 102. Thereby, an estimation algorithm for a part that supports mounting of a sensing device can be newly added, and an update can be made for the purpose of improving accuracy of an existing algorithm. In the example shown in FIG. 6, although originally only the rule-based algorithm was available as the consumed level estimation algorithm for the drum as a consumable part, the machine learning model was added later. For this reason, two types of consumed level estimation algorithms for the drum, the rule-based algorithm and the machine learning model, exist. In FIG. 6, the algorithm version of the rule-based algorithm of the drum is 1.0. For example, in a case in which the rule-based algorithm of the drum is updated (version upgrade), the algorithm version becomes 1.1. In FIG. 6, the algorithm version of the machine learning model of the drum is 2.0.

Returning to the explanation of FIG. 5, in step S403, for example, it is assumed that the data collection unit 312 selected the drum unit (for K toner). In step S404, the data collection unit 312 acquires a consumed level estimation unit (consumed level estimation algorithm). In order to select the consumed level estimation unit (consumed level estimation algorithm) to be acquired, the data collection unit 312 first confirms whether or not a sensing device is mounted. The data collection unit 312 acquires, via the drum control unit 277, whether or not a sensing device is mounted on the corresponding drum unit. In the present embodiment, explanation is continued on the assumption that the drum unit has a sensing device mounted on the drum unit. The data collection unit 312 refers to the consumed level estimation unit selection table 500, and acquires, as a consumed level estimation unit (consumed level estimation algorithm) that estimates a consumed level of the drum unit, a machine learning model having an algorithm version 2.0 that can be selected in a case in which a sensing device is present. It should be noted that, in a case in which the drum unit does not have a sensing device mounted thereupon, the data collection unit 312 will select a rule-based algorithm as the consumed level estimation unit. In this manner, when determining a consumed level estimation unit, the data collection unit 312 confirms the presence or absence of a sensing device that measures consumable parts, the data collection unit 312 selects a machine learning model in a case in which a sensing device is present, and the data collection unit 312 selects a rule-based algorithm in a case in which a sensing device is not present.

In step S405, the data collection unit 312 acquires parameters related to the consumable part that are necessary for execution of the consumed level estimation unit (consumed level estimation algorithm) that was determined in step S404. Parameters necessary for execution of the consumed level estimation algorithm include counter information corresponding to the consumable part, sensing data that is collected from a sensing device that is associated with the consumable part, and the like. It should be noted that the parameters related to the consumable part are not limited to the counter information and the sensing data.

In step S406, the data collection unit 312 performs estimation of the consumed level by using the consumed level estimation unit (consumed level estimation algorithm) that was determined in step S404. In step S407, the data collection unit 312 acquires the current date-time information. In step S408, the data collection unit 312 associates the consumed level that was estimated in step S406, the consumed level estimation unit (consumed level estimation algorithm) that was used in the estimation in step S406, and the date-time information that was acquired in step S407, and stores the consumed level that was estimated in step S406, the consumed level estimation unit (consumed level estimation algorithm) that was used in the estimation in step S406, and the date-time information that was acquired in step S407 in the HDD 253. It should be noted that, as information of the consumed level estimation unit (consumed level estimation algorithm) that was used in the estimation in step S406, an algorithm version corresponding to the consumed level estimation algorithm is stored. For example, in a case in which a machine learning model is used for estimation of the consumed level of the drum, algorithm version 2.0 is stored as information of the consumed level estimation unit (consumed level estimation algorithm). In step S409, the data collection unit 312 deletes from the list of unprocessed consumable parts the consumable part that was selected in step S403 and was the target of the consumed level estimation processing. Then, the data collection unit 312 returns to step S402 and performs confirmation as to whether an unprocessed consumable part is present.

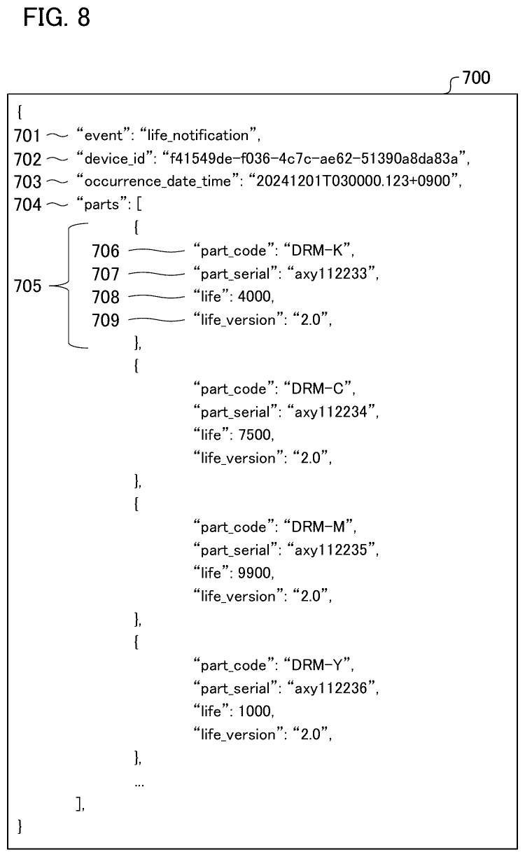

In this manner, by repeating consumed level estimation processing for each consumable part, the data collection unit 312 of the device 102 estimates the consumed level for each consumable part. Thereafter, the consumed level that the data collection unit 312 estimated for each consumable part by the consumed level estimation processing (FIG. 5) is transmitted to the part lifespan prediction server 101 by the data collection notification unit 313. More specifically, the data collection notification unit 313 acquires information that was stored in the HDD 253 in step S408 and that associates the estimated consumed level, the consumed level estimation unit (consumed level estimation algorithm) that was used in the estimation, and date-time information at which estimation processing was performed. Then, the data collection notification unit 313 notifies the part lifespan prediction server 101 of information in which the estimated consumed level of each consumable part, the consumed level estimation unit that was used in estimation of the consumed level of each consumable part, and the date-time information at which estimation processing was performed are associated, as notification information of the consumed level of the consumable parts. The notification information of the consumed level will be described below by using FIG. 8.

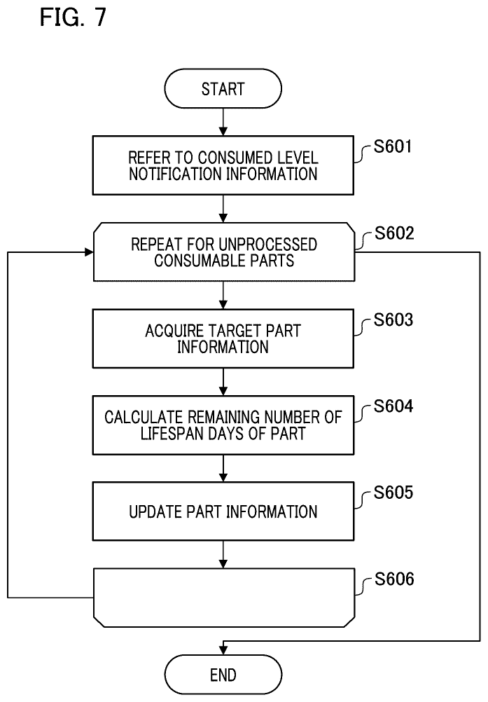

Next, processing in the part lifespan prediction server 101, with respect to calculating the remaining number of lifespan days of consumable parts of the device 102 and updating the remaining number of lifespan days of the consumable parts, is explained. FIG. 7 is a flowchart showing update processing of a remaining number of lifespan days of parts. Each processing that the part lifespan prediction server 101 executes is stored as executable code of a program in the HDD 203 of the part lifespan prediction server 101, and is loaded into the memory 202 and executed by the CPU 201.

The present processing is started when a notification of the consumed level of consumable parts from the data collection notification unit 313 of the device 102 is received by the part information reception unit 304 of the part lifespan prediction server 101. Information included in a notification of the consumed level of consumable parts of the device 102 that is received at the part information reception unit 304 is managed by the part information management unit 302. It should be noted that the processing may be performed at various timings, for example by storing received information from a given device 102 at the part information reception unit 304, periodically executing the processing on an internal schedule that is specific to the part lifespan prediction server 101, and the like.

In step S601, the part lifespan prediction unit 303 refers to notification information of the consumed level that was notified from the device 102. In this context, notification information is information in which the estimated consumed level of each consumable part, the consumed level estimation unit that was used in estimation of the consumed level of each consumable part, and date-time information at which estimation processing was performed are associated. Specifically, the notification information is text information shown in FIG. 8.

FIG. 8 is a diagram showing an example of notification information of the consumed level of consumable parts. A notification information 700 includes a notification event type 701, a device-specific ID 702, an event occurrence date-time 703, and a parts list 704. Then, the parts list 704 includes part consumed level information 705 for each consumable part. The part consumed level information 705 includes a part code 706, a part serial 707, a consumed level 708, and a consumed level estimation algorithm version 709. In the event type 701, a value is written that indicates that the event is a notification event of the consumed level of a consumable part. The device-specific ID 702 is information that uniquely identifies the device 102. The event occurrence date-time 703 is the date-time that was acquired in step S407. The part code 706 is a part type. The part serial 707 is information that uniquely identifies the part. The consumed level 708 is a consumed level that was estimated in step S406 for the part. The consumed level estimation algorithm version 709 is information that indicates the consumed level estimation unit (consumed level estimation algorithm) that was used in the estimation in step S406.

In step S602, the part lifespan prediction unit 303 refers to the parts list 704 in the notification information 700, and the part lifespan prediction unit 303 enters iterative processing with respect to unprocessed parts (part consumed level information 705). Processing of updating remaining number of lifespan days of consumable parts in step S603 to step S605 is executed iteratively with respect to unprocessed part consumed level information 705. In step S602, the part lifespan prediction unit 303 confirms whether unprocessed part consumed level information is present in the parts list 704. In a case in which unprocessed part consumed level information is present, the part lifespan prediction unit 303 selects one item of part consumed level information to be processed, and the part lifespan prediction unit 303 proceeds to processing of updating remaining number of lifespan days of consumable parts. In contrast, in a case in which unprocessed part consumed level information is not present, specifically, in a case in which processing of updating remaining number of lifespan days of consumable parts has ended for all part consumed level information of the parts list 704, the part lifespan prediction unit 303 ends the present processing. In processing in a first execution of step S602, the part lifespan prediction unit 303 selects, as a processing target, the part consumed level information 705 that is the topmost part consumed level information in the parts list 704 in the notification information 700.

In step S603, the part lifespan prediction unit 303 acquires part information corresponding to the part identified by the part consumed level information that was selected as the processing target in step S602 from the part information management unit 302. Here, the part information that is acquired is managed by the part information management unit 302 of the part lifespan prediction server 101. The part lifespan prediction unit 303 requests the part information management unit 302 to search for part information using the part serial 707 included in the part consumed level information of the processing target as a key. The part information management unit 302 acquires part information corresponding to the part serial 707 by searching, and the part information management unit 302 sends the part information to the part lifespan prediction unit 303. In this manner, the part lifespan prediction unit 303 can acquire, from the part information management unit 302, part information that corresponds to the part consumed level information of the processing target and that is managed by the part lifespan prediction server 101. Here, part information is explained by using FIG. 9.

FIG. 9 is a diagram showing an example of a part information table. FIG. 9 shows part information with respect to one part. A part information table 800 is configured by pairs of items and values corresponding to the items. For example, part_serial is an item indicating a part serial, and device_id is an item indicating a device-specific ID of a device on which the part is mounted. In the example shown in FIG. 9, it is recorded that the part serial is axy112233 and that the device-specific ID of the device on which the part is mounted is f41549de-f036-4c7c-ae62-51390a8da83a.

part_number is an item indicating a part number. life_a_day is an item indicating lifespan progress per day. life_full is an item indicating an assumed lifespan of the part. life_days is an item indicating the number of days until the lifespan is reached. part_code is an item indicating a part code. life_progress is an item indicating consumption progress. life_version is an item indicating an algorithm version of the consumed level estimation algorithm. initial_learning is an item indicating a flag representing that initial learning is in progress. learning_start_date is an item indicating a learning start date.

Returning to the explanation of FIG. 7, in step S604, the part lifespan prediction unit 303 calculates remaining number of lifespan days of the part that is the processing target. For example, the part lifespan prediction unit 303 calculates a part lifespan from consumption progress (life_progress) included in the part information table 800 that was acquired in step S603 and from the consumed level 708 in the part consumed level information 705, and the part lifespan prediction unit 303 sets a difference from a recommended replacement lifespan that is set separately as the remaining number of lifespan days of the part. It should be noted that, for lifespan prediction, general methods (a moving average method, an exponential smoothing method, ARIMA, a method using a neural network, and the like) can be used, and a method for lifespan prediction is not particularly limited.

In this context, an explanation is provided with respect to a specific example of processing of calculating remaining number of lifespan days. As one example, an assumed lifespan of the part is set to 10000, and a prediction coefficient that is settable by a user of the system is set to 1.4. A lifespan value of 14000 that is obtained by multiplying the assumed lifespan of the part and the prediction coefficient becomes the part lifespan. As learning data in the present embodiment, information such as a tendency of change in the consumed level per day (an amount of increase of the consumed level that is leveled by taking into account cycles including holidays and the like) is assumed to be held based on transition of the consumed level over the most recent 60 days. In this context, the consumed level is assumed to increase by 50 per day. Since current consumption progress is 4000, if the remaining 10000 until the lifespan decreases by 50 per day, the number of days until the lifespan is reached can be calculated as 200 days.

It should be noted that, in the present embodiment, although fixed processing of calculating remaining number of lifespan days is applied, different processing may be applied according to the consumed level estimation algorithm version 709 in the notification information 700. For example, although the consumed level simply increases if consumed level estimation is a counter-based algorithm, in a case in which consumed level estimation is based on sensing data, there are cases in which the consumed level slightly decreases over a short period, and processing of calculating remaining number of lifespan days that takes such a transition of the consumed level into consideration may be applied.

In step S605, the part lifespan prediction unit 303 instructs the part information management unit 302 to perform update of part information. On this occasion, the part lifespan prediction unit 303 stores the consumed level estimation algorithm version 709 in the notification information 700 that was notified from the device 102 as life_version=2.0. In addition, the part lifespan prediction unit 303 similarly updates and stores values of each item of other updated part information.

By processing of updating remaining number of lifespan days of consumable parts in steps S603 to S605 described above, calculation of remaining number of lifespan days with respect to one consumable part is executed, and processing returns to step S602 via step S606. Thereafter, similarly, with respect to unprocessed parts, processing that updates the remaining number of lifespan days of the parts by calculating is repeated. When processing of remaining number of lifespan days has been executed with respect to all consumable parts, the present flow ends.

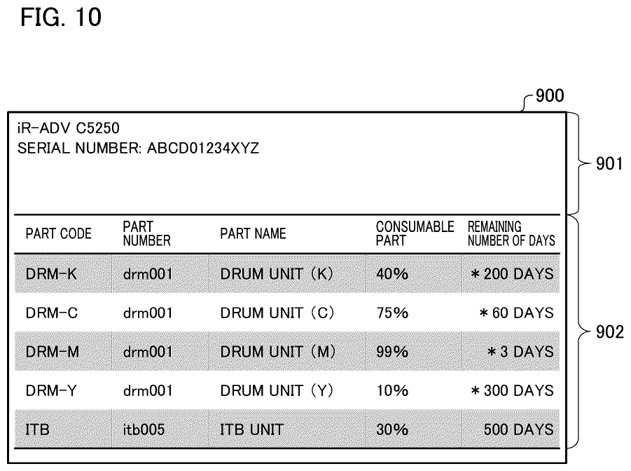

FIG. 10 is a diagram showing an example of a part information display screen. A part information display screen 900 is a web application screen that is provided by the UI management unit 305 of the part lifespan prediction server 101. The UI management unit 305 generates the part information display screen 900 based on device information that is managed by the device management unit 301 and part information that is managed by the part information management unit 302, and the UI management unit 305 provides the part information display screen 900 to a terminal of a user of the system via a web browser. When the part lifespan prediction server 101 detects that a device was selected by the user on a menu screen and the like of the web application, the part lifespan prediction server 101 provides the part information display screen 900 of the selected device.

The part information display screen 900 includes a device information display region 901 and a part information display region 902. In the device information display region 901, for example, device information including a model name, a serial number, and the like of the selected device is displayed. In the part information display region 902, for example, a part code, a part number, a part name, a consumed level, and a remaining number of days of parts that are mounted on the device are displayed in list format. In the example shown in FIG. 10, drums (K, C, M, and Y) and an ITB unit are displayed. It should be noted that the part information is not limited thereto, and, for example, other items including a cumulative number of sheets passed and the like may be displayed.

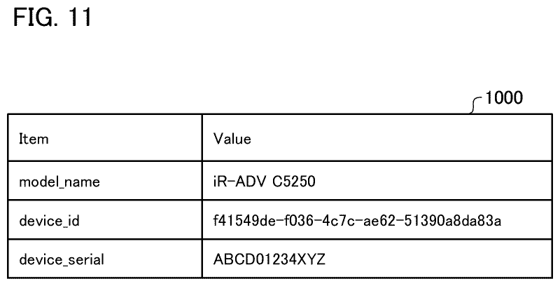

The UI management unit 305 acquires information to be displayed in the device information display region 901 from the device management unit 301. FIG. 11 shows an example of device information that is acquired from the device management unit 301. FIG. 11 is a diagram showing an example of a device information table. In device information 1000, for example, a model name (“model_name”) and a serial number (“device_serial”) are managed in association with a device-specific ID (“device_id”). The UI management unit 305 displays the model name and the device-specific ID in the device information display region 901.

The UI management unit 305 acquires information to be displayed in the part information display region 902 from the part information management unit 302. Information that is acquired from the part information display region 902 is the part information shown in FIG. 9. The UI management unit 305 displays a part code, a part number, a part name, a consumed level, and a remaining number of days in the part information display region 902. In addition, in the present embodiment, when displaying the remaining number of days, the UI management unit 305 performs display that enables a user to recognize an accuracy of estimation of the remaining number of days. For example, the UI management unit 305 performs display of information based on a type of consumed level estimation unit so that the user can recognize the accuracy of the estimation. In the present embodiment, in a case in which a consumed level estimation unit (consumed level estimation algorithm) having high accuracy is used in estimation of the consumed level, the UI management unit 305 performs display that enables the user to identify the accuracy of estimation of the remaining number of days by performing highlighted display.

In this context, an explanation is provided with respect to necessity of performing display of information based on a type of consumed level estimation unit so that the user of the system can recognize accuracy of estimation of the remaining number of days together with the lifespan of the consumable part. Update of the consumed level estimation unit (consumed level estimation algorithm) used for estimation of the consumed level from an old consumed level estimation unit to a new consumed level estimation unit is performed by, for example, a device firmware update and the like. However, firmware update is performed for each device, and for this reason the new and old consumed level estimation units become mixed among numerous devices for which the customer engineer is responsible for maintenance. As the consumed level estimation unit is updated and estimation of the consumed level becomes higher in accuracy, prediction accuracy of lifespan of parts also becomes higher in accuracy. As a result, predictions of lifespans having different accuracies for each device or each part are displayed in the UI provided by the part lifespan prediction server 101. In addition, although replacement of consumable parts is desirably performed before an end of the lifespan, an error of a period that is recommended for replacement based on the lifespan (replacement recommended day) differs between the new and old consumed level estimation units. In a case in which the lifespan is calculated based on the old consumed level estimation unit having accuracy lower than the new consumed level estimation unit, the error becomes large, and, for the purpose of not causing failure, early replacement within the error range is recommended. In contrast, in a case in which the lifespan is calculated based on the new consumed level estimation unit, the error is small, and, for this reason, when part replacement is performed on the replacement day that is recommended in a case of the old consumed level estimation unit, part replacement may be too early. In this manner, if the customer engineer who is the user of the system cannot recognize which of the new and old consumed level estimation units was used to calculate the consumed level on which the lifespan prediction is based, determination of appropriate replacement timing of parts becomes difficult. For this reason, in the present embodiment, information based on the consumed level estimation unit is displayed in the UI as information indicating accuracy of estimation of the remaining number of days together with the lifespan of the consumable part, and the user of the system is notified.

For example, in a case in which the remaining number of days is a remaining number of days based on consumed level estimation having higher accuracy using data derived from a sensing device, the UI management unit 305 displays a mark of “*” and the like before the remaining number of days. In the example shown in FIG. 10, for the purpose of indicating that the remaining number of days is a remaining number of days based on consumed level estimation having higher accuracy for parts of the drum unit for which life_version is 2.0 and the consumed level was estimated using a machine learning model, a mark * is displayed before the remaining number of days. In contrast, for an ITB for which life_version is 1.0 and the consumed level was estimated using a conventional rule-based algorithm, a mark indicating that the remaining number of days is a remaining number of days based on consumed level estimation having higher accuracy is not displayed. In this manner, in a case in which an algorithm version is 2.0, a mark indicating that the remaining number of days is a remaining number of days based on consumed level estimation having higher accuracy is displayed, and in a case in which the algorithm version is 1.0, the mark is not displayed. It is possible to set in advance for which algorithm version consumed level estimation having higher accuracy can be performed and for which algorithm version a mark is to be displayed indicating that the remaining number of days is based on consumed level estimation having higher accuracy. Thereby, in a case in which a consumed level estimation unit that was used for estimation of the consumed level, the estimation being used in prediction of the lifespan, is of a version newer than a predetermined version, display notification can be performed indicating that the lifespan prediction is highly accurate. In addition, in a case in which a numerical value of an algorithm version is larger than a numerical value of a previous algorithm version, or in a case in which a numerical value of a ones digit of an algorithm version is larger, the mark indicating that the remaining number of days is a remaining number of days based on consumed level estimation having higher accuracy may be displayed. It should be noted that a method for the highlighted display indicating that the remaining number of days is a remaining number of days based on consumed level estimation having higher accuracy using data derived from a sensing device is not limited, for example, to display by using a specific color instead of a mark and the like.

It should be noted that, although FIG. 10 shows an example in which highlighted display is performed in a case in which a remaining number of days is a remaining number of days based on consumed level estimation having higher accuracy using data derived from a sensing device, the present embodiment is not limited thereto. For example, as information based on a type of consumed level estimation unit, a consumed level estimation unit (consumed level estimation algorithm) or an algorithm version may be displayed as is with respect to all parts. That is, with respect to each part, a type of consumed level estimation unit (consumed level estimation algorithm) that was used for estimation of the consumed level used in prediction of the lifespan may be displayed. In addition, it is sufficient that a system user be able to recognize accuracy of a remaining number of days according to a consumed level estimation unit (consumed level estimation algorithm) that was used in estimation of the consumed level, by displaying a tooltip during mouseover and the like.

It should be noted that, although in the present embodiment a method of consumed level estimation is directly represented in the form of an algorithm version, the present embodiment is not limited thereto. For example, the method of consumed level estimation may be notified in an indirect format, for example in notification information in which a consumed level that is estimated based on condition data and a consumed level that is estimated by a conventional counter method are listed together and the like.

As explained above, in the present embodiment, information on a method of consumed level estimation is acquired, and accuracy of a remaining number of days corresponding to the information on the method of consumed level estimation is displayed on a screen in a manner that enables the accuracy to be recognized. As a result, a system user becomes able to recognize which part has high accuracy of a remaining lifespan, and the system user becomes able to recognize for which part a consumed level estimation unit (consumed level estimation algorithm) having high accuracy has been used in estimation of the remaining lifespan. That is, in a system that predicts a lifespan of consumable parts of a device, a system user becomes able to recognize a consumed level estimation unit that has been used.

### Second Embodiment

In a Second Embodiment, in addition to processing in the First Embodiment, processing that clears learning data of prediction of a number of days of lifespan is performed by a change of a consumed level estimation unit (consumed level estimation algorithm). When a consumed level estimation unit (consumed level estimation algorithm) that is indicated by an algorithm version is changed by a firmware update of the device 102 or the like, learning data based on consumed levels that are obtained by two types of algorithms becomes mixed. That is, learning data that has been obtained so far based on consumed levels that are obtained by a conventional algorithm and learning data based on consumed levels that are obtained by a new algorithm after the change are mixed. When learning data is mixed, machine learning is not performed correctly, and an adverse effect is exerted on prediction of a remaining number of lifespan days in the future. For this reason, in the present embodiment, the learning data is cleared at a time at which the consumed level estimation unit (consumed level estimation algorithm) is changed. Hereinafter, only differences from the First Embodiment are explained.

In step S604 in update processing of a remaining number of lifespan days of a part (FIG. 7) in the part lifespan prediction server 101, the part lifespan prediction unit 303 calculates a remaining number of lifespan days of a part that is a processing target. In the present embodiment, at a time of calculation of the remaining number of lifespan days, the part lifespan prediction unit 303 further confirms whether an algorithm version of notification information 709 is the same as an algorithm version (life_version) that is stored as part information table 800. In a case in which the algorithm versions differ, the part lifespan prediction unit 303 can determine that a change has occurred in an algorithm of consumed level estimation due to a firmware update of the device 102 or the like. In a case in which the algorithm versions differ, learning data that has been obtained so far based on consumed levels that are obtained by a conventional algorithm becomes mixed, and there is a possibility that an adverse effect is exerted on prediction of a remaining number of lifespan days in the future. For this reason, the part lifespan prediction unit 303 performs processing that clears learning data of prediction of a number of days of lifespan.

As processing that clears learning data of prediction of a number of days of lifespan, the part lifespan prediction unit 303 performs updating to predetermined values when the part lifespan prediction unit 303 updates part information in step S605. Specifically, the part lifespan prediction unit 303 instructs the part information management unit 302 to update progress of a lifespan in one day (life_a_day) to “no value” and to update a flag indicating that initial learning is in progress (initial_learning) to “true”. Furthermore, the part lifespan prediction unit 303 instructs the part information management unit 302 to update a learning start date (learning_start_date) to a current date. In this manner, in a case in which a consumed level estimation unit that is used for estimation of the consumed level used in prediction of lifespan is changed, the part lifespan prediction unit 303 resets learning data of prediction of lifespan based on consumed levels that are estimated by using a consumed level estimation unit before the change.

In a case in which learning data is reset and part information is in a state in which progress of a lifespan in one day is “no value” and a flag indicating that initial learning is in progress is “true”, an indication that initial learning is in progress is displayed on an application UI, and a remaining number of days of the part is also not displayed. A specific display of the application UI is “*--days (“Initial Learning In Progress”)”. It should be noted that, after indicating that initial learning is in progress, a value of a conventional remaining number of days of the part (a remaining number of days of the part that is calculated based on learning data of prediction of a number of days of lifespan for conventional prediction) may be displayed as a reference value.

A period for which a remaining number of days of the part is not displayed and an initial learning period are determined in advance as application specifications. For example, in the present embodiment, a non-display period of a remaining number of days of the part is 6 days, and an initial learning period is 34 days. For this reason, in an application UI, on and after a seventh day from an algorithm change, the remaining number of days of the part is displayed, and on and after a thirty-fifth day from the algorithm change, “Initial Learning In Progress” is no longer displayed. In this manner, in a case in which learning data is reset, the UI management unit 305 performs, for a predetermined period, display notification in the UI indicating to a system user that initial learning is in progress.

As explained above, in the present embodiment, when it is detected that an algorithm for estimation of a consumed level of a part has been changed, learning of prediction of a remaining number of lifespan days up to that point is reset. Thereby, mixing of a remaining number of lifespan days that is based on a consumed level estimated by an algorithm before the change and learning data is prevented, and prediction of a remaining number of lifespan days more accurately becomes possible.

### Third Embodiment

In the Second Embodiment, a configuration is explained in which, by a change of a consumed level calculation algorithm, learning data is reset and an indication that initial learning is in progress is displayed on an application UI for a predetermined period. Further, in a Third Embodiment, when a change of the consumed level calculation algorithm is detected, destinations such as system administrators and the like that are registered in advance are notified, via the notification unit 306, of the change of the consumed level calculation algorithm.

In step S604, the part lifespan prediction unit 303 confirms whether an algorithm version of notification information 709 is the same as an algorithm version (life_version) that is stored as part information table 800. In a case in which the algorithm versions differ, the part lifespan prediction unit 303 can determine that a change has occurred in an algorithm of consumed level estimation due to a firmware update of the device 102 or the like. In a case in which the algorithm versions differ, the part lifespan prediction unit 303 notifies the notification unit 306 that a consumed level estimation unit (consumed level estimation algorithm) has been changed. The notification unit 306 that has received the notification notifies destinations that are registered in advance that a consumed level calculation algorithm has been changed, by notification by email, push notification to a terminal, and the like. A notification that communicates a change of a consumed level calculation algorithm includes, for example, information that uniquely identifies a device and a part type for which the consumed level calculation algorithm has been changed, and content of the change of the algorithm. In this manner, the notification unit 306 becomes able to notify a user of the system that a consumed level estimation unit used for estimation of a consumed level has been changed. A user who has received the notification becomes able to recognize that a consumed level calculation algorithm has been changed.

As explained above, in the present embodiment, when a change occurs in a consumed level estimation algorithm in a device, a user of the system is enabled to receive a notification to that effect. Thereby, a user of the system becomes able to quickly take actions that are necessary for confirming information that is affected by a change of the consumed level estimation algorithm, including reconfirmation of a remaining number of days in the system and the like.

### Other Embodiments

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g. central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of Japanese Patent Application No. 2025-023347, filed Feb. 17 2025, which is hereby incorporated by reference herein in its entirety.

What is claimed is:

1. A system comprising an information processing apparatus configured to predict a lifespan of a consumable part of a device, the information processing apparatus comprising:
a memory storing instructions; and
a processor executing the instructions causing the information processing apparatus to:
receive data of a consumable part, the data having been collected in the device and including a consumed level of the consumable part and a consumed level estimation unit that was used for estimation of the consumed level;
predict a lifespan of the consumable part based on the consumed level of the consumable part included in the collected data of the consumable part received from the device; and
generate and provide a UI configured to display the predicted lifespan of the consumable part and information based on a type of the consumed level estimation unit.

2. The system according to claim 1,
wherein, in a case in which the consumed level estimation unit that was used for estimation of the consumed level, the estimation being used in prediction of the lifespan, is of a version newer than a predetermined version, the processor performs notification display indicating that the prediction of the lifespan is highly accurate.

3. The system according to claim 1,
wherein the processor displays a type of the consumed level estimation unit that was used for estimation of the consumed level, the estimation being used in lifespan prediction.

4. The system according to claim 1, wherein the processor is configured to:
perform lifespan prediction for a consumable part based on the consumed level by using learning data for lifespan prediction;
in a case in which the consumed level estimation unit that was used for estimation of the consumed level, the estimation being used in lifespan prediction, is changed, reset learning data for lifespan prediction that used the consumed level estimated by using the consumed level estimation unit before the change; and
in a case in which the learning data is reset, perform, for a predetermined period, display notification in the UI indicating that initial learning is in progress.

5. The system according to claim 4,
wherein the processor further executes an instruction causing the information processing apparatus to notify a user of the system that the consumed level estimation unit that is used for estimation of the consumed level has been changed.

6. The system according to claim 1, wherein:
the device is an image processing apparatus that is provided with a printing function;
the consumed level estimation unit is an algorithm for estimating the consumed level; and
the processor is configured to provide the UI to a terminal of a user of the system via a web browser.

7. A control method of a system comprising an information processing apparatus configured to predict a lifespan of a consumable part of a device, the method comprising:
receiving data of a consumable part, the data having been collected in the device and including a consumed level of a consumable part and a consumed level estimation unit that was used for estimation of the consumed level;
predicting a lifespan of the consumable part based on the consumed level of the consumable part included in the collected data of the consumable part received from the device; and
generating and providing a UI configured to display the predicted lifespan of the consumable part and information based on a type of the consumed level estimation unit.
